(19) United States
(12) Patent Application Publication
(10) Pub. No.: US 2026/0252175 A1
(43) Pub. Date: Aug. 27, 2026

(54) HAPTIC FEEDBACK DISPLAY DEVICE

(71) Applicants: Beijing BOE Technology Development Co., Ltd., Beijing (CN); BOE Technology Group Co., Ltd., Beijing (CN)

(72) Inventors: Jijing HUANG, Beijing (CN); Zongmin LIU, Beijing (CN); Jiawen ZHANG, Beijing (CN); He WANG, Beijing (CN)

(21) Appl. No.: 18/994,147

(22) PCT Filed: May 15, 2024
(86) PCT No.: PCT/CN2024/093456

§ 371 Date: Jan. 14, 2025

(30) Foreign Application Priority Data
Jun. 20, 2023 (CN) 202310738834.1

(51) Int. Cl. G06F 3/01; G06F 3/044; G09G 3/20

(52) U.S. Cl. CPC G06F 3/016; G09G 3/20; G06F 3/044; G09G 2330/021; G09G 2354/00

(57) ABSTRACT

Embodiments of the present disclosure provide a haptic feedback display device, comprising: a first circuit board; an adaptor connector, fixedly provided on the first circuit board and electrically connected to the first circuit board; and a functional circuit assembly, wherein the functional circuit assembly is mounted on the adaptor connector in an insertion mode, and is electrically connected to the first circuit board by means of the adapter connector.

### CROSS-REFERENCE TO RELATED APPLICATIONS

This application is a National Stage of International Application No. PCT/CN2024/093456, filed on May 15, 2024, which claims priority to Chinese Patent Application No. 202310738834.1, filed on Jun. 20, 2023, in the China National Intellectual Property Administration, with a name “Haptic feedback display device”. The entire disclosure of the above applications is incorporated herein by reference.

### TECHNICAL FIELD

The present disclosure relates to the technical field of haptics interaction, and in particular to a haptic feedback display device.

### BACKGROUND

Haptic feedback display devices are the focus of today's technological development, in which haptics can interact with the human body through the sense of touch. The haptics can be divided into two categories, one is vibration feedback and the other is haptic reproduction technology. Different haptic feedback display devices have different driving requirements due to different structures, so each haptic feedback display device needs to be driven by functional circuit components with special specifications, resulting in high development costs and long development cycles.

### SUMMARY

The present disclosure provides a haptic feedback display device, including:
a first circuit board;
an adapting connector fixedly arranged on the first circuit board and electrically connected with the first circuit board;
a functional circuit assembly mounted on the adapting connector in a plug-in mode, and electrically connected with the first circuit board through the adapting connector.

In some embodiments, the functional circuit assembly includes a power supply input circuit, the power supply input circuit is configured to provide a power supply voltage;
the adapting connector includes a first adapting connector;
the power supply input circuit is electrically connected with the first circuit board through the first adapting connector.

In some embodiments, the power supply input circuit includes: a first pin, a second pin, a third pin, a fourth pin, and a fifth pin;
the first adapting connector includes a first port, a second port, a third port, a fourth port, and a fifth port;
the first pin and the second pin are configured to be grounded; the third pin is configured to be electrically connected with a negative high-voltage signal terminal on the first circuit board; the fourth pin is configured to be electrically connected with a positive high-voltage signal terminal on the first circuit board; the fifth pin is configured to be electrically connected with a low-voltage signal terminal on the first circuit board;
the first port is electrically connected with the first pin, the second port is electrically connected with the second pin, the third port is electrically connected with the third pin, the fourth port is electrically connected with the fourth pin, and the fifth port is electrically connected with the fifth pin.

In some embodiments, the functional circuit assembly includes a voltage conversion circuit, the voltage conversion circuit is configured to convert a power supply voltage into a target voltage;
the adapting connector further includes a second adapting connector;
the voltage conversion circuit is electrically connected with the first circuit board through the second adapting connector.

In some embodiments, the voltage conversion circuit includes a sixth pin, a seventh pin, an eighth pin, a ninth pin;
the second adapting connector includes a sixth port, a seventh port, an eighth port, a ninth port;
the sixth pin and the seventh pin are configured to be grounded; the eighth pin is configured to be electrically connected with the fourth pin; the ninth pin is configured to be electrically connected with the fifth pin;
the sixth port is electrically connected with the sixth pin, the seventh port is electrically connected with the seventh pin, the eighth port is electrically connected with the eighth pin, and the ninth port is electrically connected with the ninth pin.

In some embodiments, the functional circuit assembly includes a processing control circuit, wherein the processing control circuit is configured to output a control signal;
the adapting connector includes a third adapting connector;
the processing control circuit is electrically connected with the first circuit board through the third adapting connector.

In some embodiments, the processing control circuit includes at least n pins; the third adapting connector includes at least n ports; the at least n pins are electrically connected with the at least n ports in a one-to-one manner;
x of the at least n pins are configured to be electrically connected with a control signal terminal on the first circuit board; y of the at least n pins are configured to be grounded; z of the at least n pins are configured to be electrically connected with the ninth pin, wherein n=x+y+z, n is greater than or equal to 480, x is greater than or equal to 376, y is greater than or equal to 96, and z is greater than or equal to 8.

In some embodiments, the functional circuit assembly includes a first high-voltage amplification circuit, the first high-voltage amplification circuit is configured to output a first high-voltage signal;
the adapting connector includes a fourth adapting connector;
the first high-voltage amplification circuit is electrically connected with the first circuit board through the fourth adapting connector.

In some embodiments, the first high-voltage amplification circuit includes a tenth pin, an eleventh pin, a twelfth pin, a thirteenth pin, a fourteenth pin, a fifteenth pin, a sixteenth pin, a seventeenth pin, an eighteenth pin, a nineteenth pin, a twentieth pin, a twenty-first pin, a twenty-second pin, a twenty-third pin, a twenty-fourth pin, a twenty-fifth pin, a twenty-sixth pin, a twenty-seventh pin, a twenty-eighth pin, a twenty-ninth pin, a thirtieth pin, a thirty-first pin, and a thirty-second pin;
the fourth adapting connector includes a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, a twenty-fourth port, a twenty-fifth port, a twenty-sixth port, a twenty-seventh port, a twenty-eighth port, a twenty-ninth port, a thirtieth port, a thirty-first port, and a thirty-second port;
the tenth pin is configured to be electrically connected to the third pin; the eleventh pin is configured to be electrically connected with a first high-voltage signal output terminal on the first circuit board and the fourteenth pin; the twelfth pin is configured to be electrically connected with a first resistor on the first circuit board; the thirteenth pin is configured to electrically connect with a second resistor on the first circuit board; the fifteenth pin is configured to be electrically connected with a first capacitor on the first circuit board; the sixteenth pin is configured to be electrically connected with a second capacitor on the first circuit board; the seventeenth pin and the eighteenth pin are configured to be electrically connected with a low-voltage signal output terminal on the first circuit board; the nineteenth pin, the twentieth pin, and the twenty-first pin are configured to be connected with three of the x pins; the twenty-fourth pin is configured to be grounded; the thirty-second pin is configured to be electrically connected with the fourth pin and the thirty-first pin;
the tenth pin is electrically connected with the tenth port, the eleventh pin is electrically connected with the eleventh port, the twelfth pin is electrically connected with the twelfth port, the thirteenth pin is electrically connected with the thirteenth port, the fourteenth pin is electrically connected with the fourteenth port, the fifteenth pin is electrically connected with the fifteenth port, the sixteenth pin is electrically connected with the sixteenth port, and the seventeenth pin is electrically connected with the seventeenth port, the eighteenth pin is electrically connected with the eighteenth port, the nineteenth pin is electrically connected with the nineteenth port, the twentieth pin is electrically connected with the twentieth port, the twenty-first pin is electrically connected with the twenty-first port, the twenty-second pin is electrically connected with the twenty-second port, the twenty-third pin is electrically connected with the twenty-third port, the twenty-fourth pin is electrically connected with the twenty-fourth port, the twenty-fifth pin is electrically connected with the twenty-fifth port, the twenty-sixth pin is electrically connected with the twenty-sixth port, the twenty-seventh pin is electrically connected with the twenty-seventh port, the twenty-eighth pin is electrically connected with the twenty-eighth port, the twenty-ninth pin is electrically connected with the twenty-ninth port, the thirtieth pin is electrically connected with the thirtieth port, the thirty-first pin is electrically connected with the thirty-first port, and the thirty-second pin is electrically connected with the thirty-second port.

In some embodiments, the haptic feedback display device further includes:
a reserved connector fixedly arranged on the first circuit board and electrically connected with the first circuit board; wherein the reserved connector includes at least one port.

In some embodiments, the haptic feedback display device further includes:
a low-voltage signal input circuit fixedly arranged on the first circuit board and electrically connected with a processing control circuit and a first high-voltage amplification circuit on the first circuit board,
the low-voltage signal input circuit is configured to generate and transmit a low-voltage signal to the first high-voltage amplification circuit in response to a control signal output by the processing control circuit, and the first high-voltage amplification circuit amplifies the low-voltage signal into a first high-voltage signal.

In some embodiments, the adapting connector includes a fifth adapting connector fixedly arranged on the first circuit board and electrically connected with the first circuit board;
wherein the functional circuit assembly includes a low-voltage signal input circuit, the low-voltage signal input circuit is mounted on the fifth adapting connector in a plug-in mode and electrically connected with a processing control circuit and a first high-voltage amplification circuit on the first circuit board through the fifth adapting connector, and the low-voltage signal input circuit is configured to generate and transmit a low-voltage signal to the first high-voltage amplification circuit in response to a control signal output by the processing control circuit, the first high-voltage amplification circuit amplifies the low-voltage signal into a first high-voltage signal.

In some embodiments, the haptic feedback display device further includes:
a display panel;
a display driving circuit fixedly arranged on the first circuit board and electrically connected with a processing control circuit on the first circuit board, wherein the display driving circuit is further electrically connected with the display panel through the first circuit board;
the display driving circuit is configured to control the display panel to display an image in response to a control signal output by the processing control circuit.

In some embodiments, the haptic feedback display device further includes:
a display panel;
the adapting connector includes a sixth adapting connector fixedly arranged on the first circuit board and electrically connected with the first circuit board;
the functional circuit assembly includes a display driving circuit, wherein the display driving circuit is mounted on the sixth adapting connector in a plug-in mode and is electrically connected with a processing control circuit on the first circuit board through the sixth adapting connector, and the display driving circuit is further electrically connected with the display panel through the first circuit board;
the display driving circuit is configured to control the display panel to display an image in response respond to a control signal output of the processing control circuit.

In some embodiments, the haptic feedback display device further includes:
a storage circuit fixedly arranged on the first circuit board and electrically connected with a processing control circuit on the first circuit board, wherein the storage circuit is configured to store information required by the processing control circuit.

In some embodiments, the adapting connector includes a seventh adapting connector fixedly arranged on the first circuit board and electrically connected with the first circuit board;
the functional circuit assembly includes a storage circuit, wherein the storage circuit is mounted on the seventh adapting connector in a plug-in mode, and is electrically connected with a processing control circuit on the first circuit board through the seventh adapting connector, and the storage circuit is configured to store information required by the processing control circuit.

In some embodiments, the haptic feedback display device further includes:
a second circuit board connected with the first circuit board through a cable;
at least one expansion connector fixedly arranged on the second circuit board and electrically connected with the second circuit board;
at least one second high-voltage amplification circuit corresponding to the at least one expansion connector in an one-to-one manner, wherein the at least one second high-voltage amplification circuit is mounted on the at least one expansion connector in a plug-in mode, and is electrically connected with the first circuit board through the at least one expansion connector and the second circuit board, the at least one second high-voltage amplification circuit is configured to output a first high-voltage signal.

### BRIEF DESCRIPTION OF FIGURES

FIG. 1 is a schematic diagram of some structures of a haptic feedback display device provided by an embodiment of the present disclosure;

FIG. 2 is a schematic diagram of some other structures of the haptic feedback display device provided by an embodiment of the present disclosure;

FIG. 3 is a schematic diagram of some other structures of the haptic feedback display device provided by an embodiment of the present disclosure;

FIG. 4 is a schematic diagram of some other structures of the haptic feedback display device provided by an embodiment of the present disclosure;

FIG. 5 is a schematic diagram of some other structures of the haptic feedback display device provided by an embodiment of the present disclosure;

FIG. 6 is a schematic diagram of some other structures of the haptic feedback display device provided by an embodiment of the present disclosure;

FIG. 7 is a schematic diagram of some other structures of the haptic feedback display device provided by an embodiment of the present disclosure;

FIG. 8A is a schematic diagram of some structure of a display panel provided by an embodiment of the present disclosure;

FIG. 8B is a schematic diagram of some other structures of the display panel provided by an embodiment of the present disclosure;

FIG. 8C a schematic diagram of some other structures of the display panel provided by an embodiment of the present disclosure;

FIG. 8D is a schematic diagram of some other structures of the display panel provided by an embodiment of the present disclosure;

FIG. 8E is a schematic diagram of some other structures of the display panel provided by an embodiment of the present disclosure;

FIG. 8F is a schematic diagram of the cross-sectional structure of the display panel along the CC′ direction shown in FIG. 8A;

FIG. 8G is a schematic diagram of the cross-sectional structure of a driver provided by an embodiment of the present disclosure;

FIG. 9 is a schematic diagram of some other structures of the haptic feedback display device provided by an embodiment of the present disclosure;

FIG. 10 is a schematic diagram of some other structures of the haptic feedback display device provided by an embodiment of the present disclosure;

FIG. 11 is a schematic diagram of some other structures of the haptic feedback display device provided by an embodiment of the present disclosure;

FIG. 12 is a schematic diagram of some other structures of the haptic feedback display device provided by an embodiment of the present disclosure.

### DETAILED DESCRIPTION

In order to make the purpose, technical solution and advantages of the embodiments of the present disclosure clearer, the technical solutions of the embodiments of the present disclosure will be clearly and completely described below in conjunction with the accompanying drawings of the embodiments of the present disclosure. Obviously, the embodiments described are some embodiments of the present disclosure, not all embodiments. And in the absence of conflict, the embodiments in the present disclosure and the features in the embodiments may be combined with each other. Based on the embodiments of the present disclosure described, all other embodiments obtained by a person skilled in the art without creative labor are within the scope of protection of the present disclosure.

Unless otherwise defined, the technical or scientific terms used in this disclosure shall have the ordinary meaning understood by persons with general skills in the field to which this disclosure belongs. The terms “first”, “second” and similar expressions used in this disclosure do not indicate any order, number or importance, but only to distinguish the different components. Words such as “include” or “comprise” mean that the element or object that precedes the word includes the element or object listed after the word and its equivalents, and does not exclude other elements or objects. Similar terms such as “connection” or “connected” are not limited to physical or mechanical connections, but may include electrical connections, whether direct or indirect.

It should be noted that the size and shape of each figure in the drawings do not reflect the true proportions, and the purpose is only to illustrate the contents of the present invention. And the same or similar designation at all times indicates the same or similar element or component with the same or similar function.

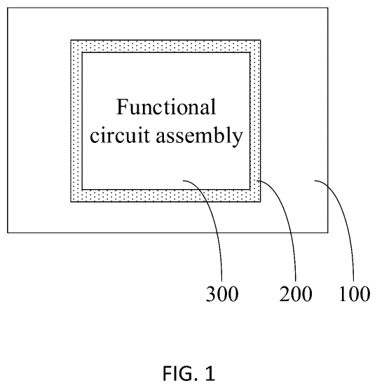

Some embodiments of the disclosure provide a haptic feedback display device, as shown in FIG. 1, including:
a first circuit board 100;
an adapting connector 200 fixedly arranged on the first circuit board 100 and electrically connected with the first circuit board 100;
a functional circuit assembly 300, the functional circuit assembly 300 is mounted on the adapting connector 200 in a plugging mode, and is electrically connected with the first circuit board 100 through the adapting connector 200.

In the haptic feedback display device provided by the embodiment of the present disclosure, by arranging an adapting connector on the first circuit board, when the functional circuit assembly needs to be connected with the first circuit board, the functional circuit assembly can be mounted on the first circuit board in a plugged mode, so that the functional circuit assembly is connected with the wiring in the first circuit board through the adapting connector to carry out signal transmission. When the functional circuit assembly needs to be replaced, the original functional circuit assembly can be removed from the adapting connector, and the new functional circuit assembly can be mounted on the first circuit board by plugging to realize the replacement of functional circuit assemblies of different specifications, so that the haptic feedback display device can be applied to different driving needs, thereby reducing the development cost and shortening the development cycle.

For example, an adapting connector can be fixed to the first circuit board, e.g. by soldering, etc., without limitation here. The adapting connectors can include Surface Mounted Technology (SMT) connectors, Dual In-line Package (DIP) connectors, etc., which are not limited here.

Exemplarily, the functional circuit assemblies in the haptic feedback display device generally include: a power input circuit, a voltage conversion circuit, a processing control circuit, a low-voltage signal input circuit, a first high-voltage amplification circuit, a storage circuit, a display drive circuit. The power input circuit is configured to provide the power supply voltage, and directly supply power to the voltage conversion circuit and the first high-voltage amplification circuit. The voltage conversion circuits are configured to convert the power supply voltage to a target voltage and supply the target voltage to the processing control circuit, the low-voltage signal input circuit, the storage circuit, and the display drive circuit. The processing control circuit is configured to output a control signal to control the voltage conversion circuit, the low-voltage signal input circuit, the first high-voltage amplification circuit, the storage circuit, and the display drive circuit to work. The low-voltage signal input circuit is configured to generate a low-voltage signal and transmit the low-voltage signal to the first high-voltage amplification circuit. The first high-voltage amplification circuit is configured to amplify the low-voltage signal into the first high-voltage signal. The storage circuit is configured to store the information required to the process control circuit. The display driver circuit is configured to control the display panel to display the screen.

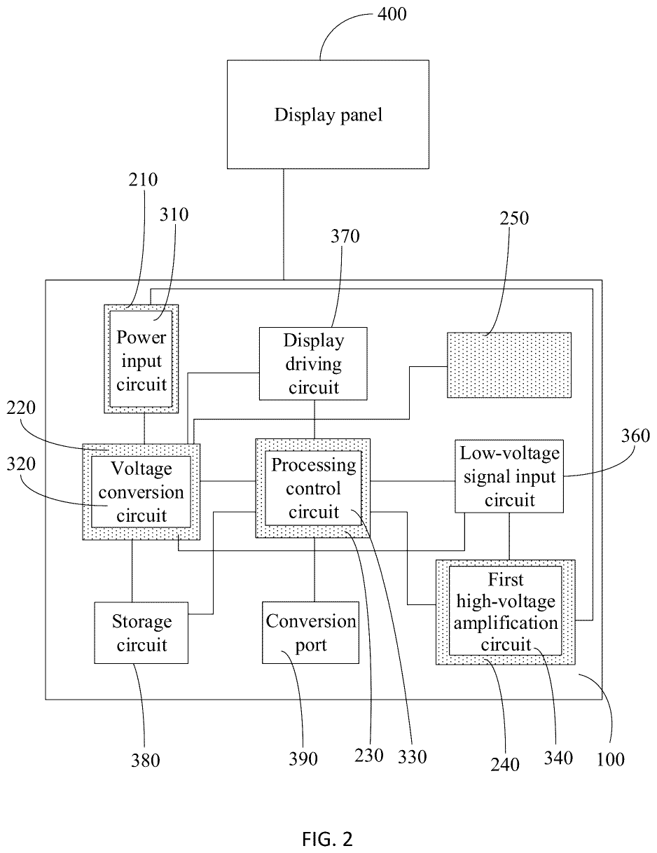

In some embodiments of the present disclosure, as shown in FIG. 1 and FIG. 2, the functional circuit assembly 300 includes a power input circuit 310. The power input circuit 310 is configured to provide a power supply voltage. The adapting connector 200 includes a first adapting connector 210. The power input circuit 310 is electrically connected with the first circuit board 100 through the first adapting connector 210.

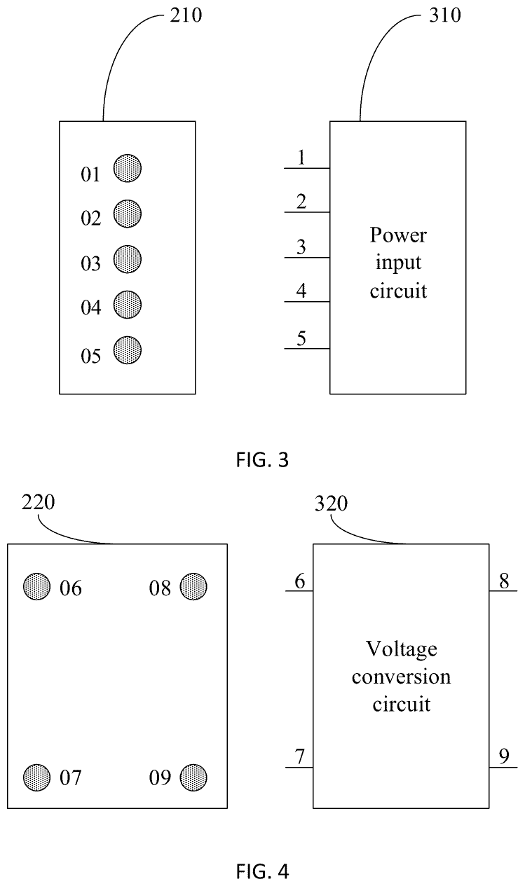

In some embodiments of the present disclosure, as shown in FIG. 2 and FIG. 3, the power input circuit 310 includes a first pin 1, a second pin 2, a third pin 3, a fourth pin 4, a fifth pin 5. The first adapting connector 210 includes a first port 01, a second port 02, a third port 03, a fourth port 04, and a fifth port 05. The first pin 1 and the second pin 2 are configured to be grounded. The third pin 3 is configured to electrically connect with the negative high-voltage signal terminal on the first circuit board 100. The fourth pin 4 is configured to electrically connect with a positive high-voltage signal terminal on the first circuit board 100. The fifth pin 5 is configured to electrically connect with the low-voltage signal terminal on the first circuit board 100. The first port 01 is electrically connected to the first pin 1, the second port 02 is electrically connected to the second pin 2, the third port 03 is electrically connected to the third pin 3, the fourth port 04 is electrically connected to the fourth pin 4, and the fifth port 05 is electrically connected to the fifth pin 5.

For example, the power supply voltage provided by the power input circuit includes a positive high voltage signal, a negative high voltage signal and a low voltage signal, so as to supply power to the haptic feedback display device. The power input circuit is mounted in the first adapting connector by means of cable connection. The haptic feedback display device can adopt power input circuits of different specifications for different driving needs. For example, when the power voltage provided by the power input circuit mounted on the first adapting connector cannot meet the power supply requirements of the haptic feedback display device, the power input circuit can be removed from the first adapting connector, and the power input circuit needs to be replaced with a new power input circuit that can meet the power supply requirements of the haptic feedback display device.

In addition, because the power input circuit directly supplies power to the first high-voltage amplifier circuit through the traces on the first circuit board, the magnitude and power of the power supply voltage provided by the power supply input circuit determine the voltage value and output power value of the first high-voltage signal output by the first high-voltage amplifier circuit. The first adapting connector can pass a larger current, for example, the maximum current that can pass through is 5 A, of course, it can also pass through the current of other values, which can be set according to the demand, and is not limited here.

In some embodiments of the present disclosure, as shown in FIG. 1 and FIG. 2, the functional circuit assembly 300 includes a voltage conversion circuit 320. The voltage conversion circuit 320 is configured to convert the supply voltage to a target voltage. The adapting connector 200 includes a second adapting connector 220. The voltage conversion circuit 320 is electrically connected with the first circuit board 100 through the second adapting connector 220.

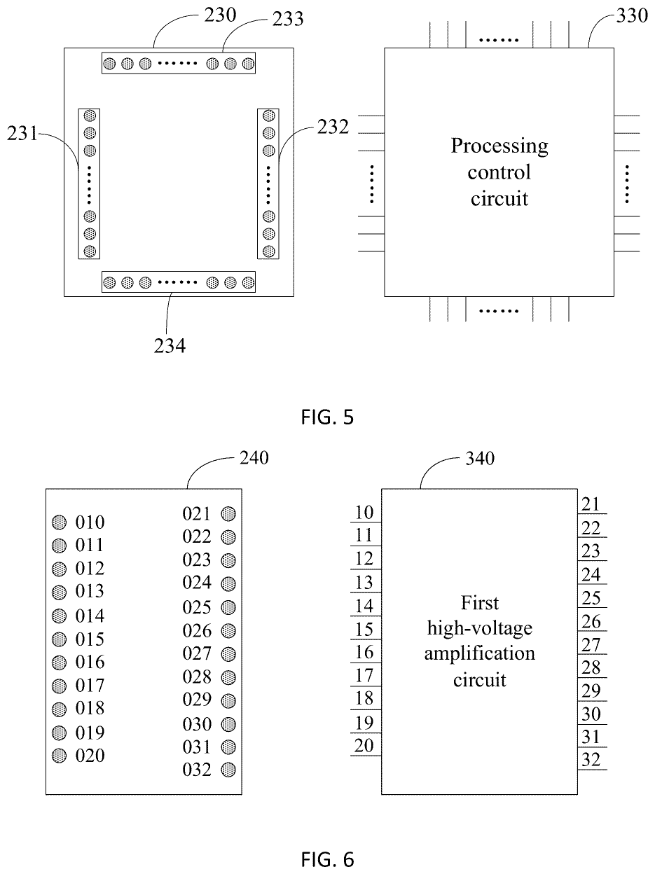

In some embodiments of the present disclosure, as shown in FIG. 2 and FIG. 4, the voltage conversion circuit 320 further includes a sixth pin 6, a seventh pin 7, an eighth pin 8, and a ninth pin 9. The second adapting connector 220 further includes a sixth port 06, a seventh port 07, an eighth port 08, and a ninth port 09. The sixth pin 6 and the seventh pin 7 are configured to be grounded. The eighth pin 8 is configured to be electrically connected to the fourth pin 4. The ninth pin 9 is configured to be electrically connected to the fifth pin 5. The sixth port 06 is electrically connected with the sixth pin 6, the seventh port 07 is electrically connected with the seventh pin 7, the eighth port 08 is electrically connected with the eighth pin 8, and the ninth port 09 is electrically connected with the ninth pin 9.

For example, the voltage conversion circuit is mounted on the second adapting connector in a plugging mode. The voltage conversion circuit can convert the power supply voltage provided by the power input circuit into a target voltage (such as 12V), and the target voltage (such as 12V) is input into the processing control circuit, the low-voltage signal input circuit, the storage circuit and the display drive circuit to supply power to the processing control circuit, the low-voltage signal input circuit, the storage circuit and the display drive circuit. Moreover, because the processing control circuit, the low-voltage signal input circuit, the storage circuit and the display drive circuit are all powered by the voltage conversion circuit, thereby effectively avoiding the change of the power supply voltage input by the power input circuit, which may result in the problem that other circuits cannot work normally in the future. Since there is a certain range of power supply voltage for making the voltage conversion circuit work normally, when the range of the supply voltage changes, the appropriate voltage conversion circuit can be selected to ensure the output of the subsequent target voltage (such as 12V). For example, if the supply voltage is currently V1, the current voltage conversion circuit mounted on the second adapting connector can convert V1 to the target voltage. If the power supply voltage increases to V2, the current voltage conversion circuit mounted on the second adapting connector cannot support the conversion of V2, and the current voltage conversion circuit needs to be replaced with a new voltage conversion circuit that can support the conversion of V2. The current voltage conversion circuit can be removed from the second adapting connector, and the new voltage conversion circuit can be mounted on the second adapting connector, so that the new voltage conversion circuit can be configured to convert V2 to the target voltage.

In some embodiments of the present disclosure, as shown in FIG. 1 and FIG. 2, the functional circuit assembly 300 includes a processing control circuit 330. The processing control circuit 330 is configured to output a control signal. The adapting connector 200 includes a third adapting connector 230. The processing control circuit 330 is electrically connected with the first circuit board 100 through the third adapting connector 230.

In some embodiments of the present disclosure, the processing control circuit includes at least n pins. The third adapting connector includes at least n ports. n pins and n ports are electrically connected in a one-to-one manner. x of n pins are configured to electrically connect with the control signal terminal on the first circuit board. Y of the n pins are configured to be grounded. z of n pins are configured to electrically connect with the ninth pin. n=x+y+z, n is greater than or equal to 480, x is greater than or equal to 376, y is greater than or equal to 96, and z is greater than or equal to 8.

For example, the processing control circuit is mounted on the third adapting connector in a plugging mode, the processing control circuit with an advanced RISC machine (ARM) core can be used for the haptic feedback display device with complex computation and the need to mount the system. The processing control circuit without an advanced RISC machine (ARM) core can be used for the haptic feedback display device that does not need to mount the system and the calculation is not complicated to reduce costs.

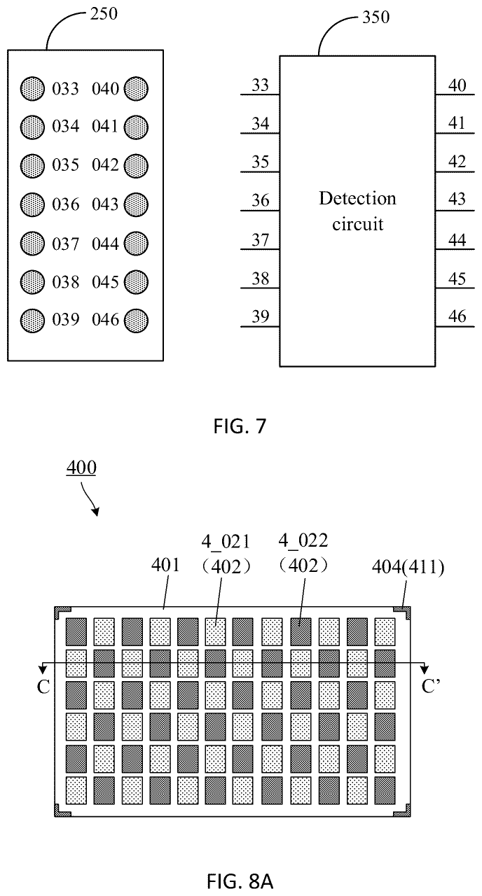

For example, as shown in FIG. 5, the third adapting connector includes four third sub-adapting connectors 231, 232, 233, and 234. Each third sub-adapting connector has 120 ports, so that for every 5 ports is a group of ports, then each third sub-adapting connector has 24 groups of ports, and one port in each group of ports is configured to be grounded. Two groups of ports in the third sub-adapting connector 232 are configured to input a target voltage (e.g., 5V) to supply power to the processing control circuit, and the other ports not mentioned are configured to provide control signals at the control signal terminal. The positions of the third sub-adapting connectors 231, 232, 233, 234 are shown in FIG. 5. The third sub-adapting connectors 231, 232 are not centered, but are moved down a distance from the center, so as to avoid causing the processing control circuit to burn out due to reverse insertion of the processing control circuit. The third sub-adapting connector 231, 232 can also be moved up a distance from the center, as long as it is not centered, which is not limited here.

In some embodiments of the present disclosure, as shown in FIG. 1 and FIG. 2, the functional circuit assembly 300 includes a first high-voltage amplification circuit 340. The first high-voltage amplification circuit 340 is configured to output a first high-voltage signal. The adapting connector 200 includes a fourth adapting connector 240. The first high-voltage amplification circuit 340 is electrically connected with the first circuit board 100 through the fourth adapting connector 240.

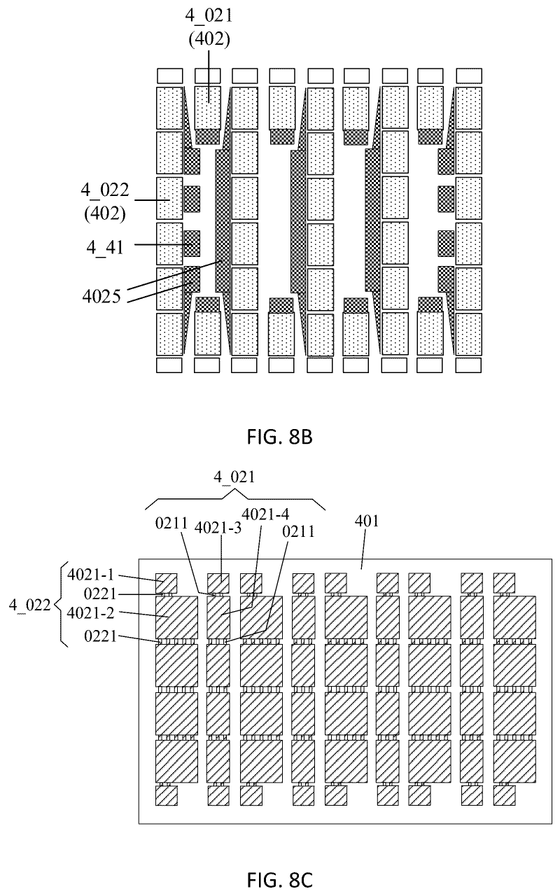

In some embodiments of the present disclosure, as shown in FIG. 6, the first high-voltage amplification circuit 340 includes a tenth pin 10, an eleventh pin 11, a twelfth pin 12, a thirteenth pin 13, a fourteenth pin 14, a fifteenth pin 15, a sixteenth pin 16, a seventeenth pin 17, an eighteenth pin 18, a nineteenth pin 19, a twentieth pin 20, a twenty-first pin 21, a twenty-second pin 22, a twenty-third pin 23, a twenty-fourth pin 24, a twenty-fifth pin 25, a twenty-sixth pin 26, a twenty-seventh pin 27, a twenty-eighth pin 28, a twenty-ninth pin 29, a thirtieth pin 30, a thirty-first pin 31, and a thirty-second pin 32. The fourth adapting connector 240 includes a tenth port 010, an eleventh port 011, a twelfth port 012, a thirteenth port 013, a fourteenth port 014, a fifteenth port 015, a sixteenth port 016, a seventeenth port 017, an eighteenth port 018, a nineteenth port 019, a twentieth port 020, a twenty-first port 021, a twenty-second port 022, a twenty-third port 023, a twenty-fourth port 024, a twenty-fifth port 025, a twenty-sixth port 026, a twenty-seventh port 027, a twenty-eighth port 028, a twenty-ninth port 029, a thirtieth port 030, a thirty-first port 031, and a thirty-second port 032. The tenth pin 10 is configured to be electrically connected with the third pin 3. The eleventh pin 11 is configured to be electrically connected with the first high-voltage signal output terminal on the first circuit board and the fourteenth pin 14. The twelfth pin 12 is configured to be electrically connected with the first resistor on the first circuit board. The thirteenth pin 13 is configured to be electrically connected with a second resistor on the first circuit board. The fifteenth pin 15 is configured to be electrically connected with the first capacitor on the first circuit board. The sixteenth pin 16 is configured to be electrically connected with a second capacitor on the first circuit board. The seventeenth pin 17 and the eighteenth pin 18 are configured to be electrically connected with the low-voltage signal output terminals on the first circuit board. The nineteenth pin 19, the twentieth pin 20, and the twenty-first pin 21 are configured to be connected with 3 of the x pins. The twenty-fourth pin 24 is configured to be grounded. The thirty-second pin 32 is configured to be electrically connected with the fourth pin 4 and the thirty-first pin 31. The tenth pin 10 is electrically connected with the tenth port 010. The eleventh pin 11 is electrically connected with the eleventh port 011. The twelfth pin 12 is electrically connected with the twelfth port 012. The thirteenth pin 13 is electrically connected with the thirteenth port 013. The fourteenth pin 14 is electrically connected with the fourteenth port 014. The fifteenth pin 15 is electrically connected with the fifteenth port 015. The sixteenth pin 16 is electrically connected with the sixteenth port 016. The seventeenth pin 17 is electrically connected with the seventeenth port 017. The eighteenth pin 18 is electrically connected with the eighteenth port 018. The nineteenth pin 19 is electrically connected with the nineteenth port 019. The twentieth pin 20 is electrically connected with the twentieth port 020. The twenty-first pin 21 is electrically connected with the twenty-first port 021. The twenty-second pin 22 is electrically connected with the twenty-second port 022. The twenty-third pin 23 is electrically connected with the twenty-third port 023. The twenty-fourth pin 24 is electrically connected with the twenty-fourth port 024. The twenty-fifth pin 25 is electrically connected with the twenty-fifth port 025. The twenty-sixth pin 26 is electrically connected with the twenty-sixth port 026. The twenty-seventh pin 27 is electrically connected with the twenty-seventh port 027. The twenty-eighth pin 28 is electrically connected with the twenty-eighth port 028. The twenty-ninth pin 29 is electrically connected with the twenty-ninth port 029. The thirtieth pin 30 is electrically connected with the thirtieth port 030. The thirty-first pin 31 is electrically connected with the thirty-first port 031. The thirty-second pin 32 is electrically connected with the thirty-second port 032.

For example, the first high-voltage amplifier circuit is mounted on the fourth adapting connector in a plugging mode. Each haptic feedback display device product can adopt a different first high-voltage amplifier circuit according to the specific needs of the driving voltage, so as to make a reasonable choice in terms of cost and power. The pins of the first high-voltage amplifier circuit are defined as shown in Table 1 below.

TABLE 1

| | |
|---|---|
| 10 | Negative high voltage signal |
| 11 | First high voltage signal |
| 12 | Positive current Limit |
| 13 | Negative current limit |
| 14 | Auxiliary negative voltage |
| 15 | First external capacitor |
| 16 | Second external capacitor |
| 17 | Negative low voltage signal |
| 18 | Positive low voltage signal |
| 19 | Temperature monitoring |
| 20 | Test pin |
| 21 | Enable Signal |
| 22 | Reserved |
| 23 | Reserved |
| 24 | GND |
| 25 | Reserved |
| 26 | Reserved |
| 27 | Reserved |
| 28 | Reserved |
| 29 | Reserved |
| 30 | Reserved |
| 31 | Auxiliary positive voltage |
| 32 | Positive high voltage signal |

For example, as shown in Table 1, 8 pins are reserved in addition to the conventional pins, so as to be configured to adapt to the first high-voltage amplification circuit of different specifications. The tenth pin 10 receives a negative high-voltage signal through the third pin. The thirty-second pin 32 receives a positive high-voltage signal through the fourth pin, that is, it is directly connected with the power input circuit 310. The seventeenth pin 17 and the eighteenth pin 18 are connected with the low-voltage signal output circuit. The seventeenth pin 17 is configured to receive a negative low-voltage signal, and the eighteenth pin 18 is configured to receive a positive low-voltage signal. The eleventh pin 11 is configured to output a first high-voltage signal, and the first high-voltage signal is configured to drive a driver (such as a piezoelectric sheet, a linear motor or a piezoelectric film) to cause the driver to vibrate. The twelfth pin 12 is electrically connected to the first resistor, thereby limiting the current flowing in the positive direction, and protecting the first high-voltage amplification circuit. The thirteenth pin 13 is electrically connected to a second resistor, thereby limiting the current flowing in the negative direction, and protecting the first high-voltage amplification circuit. The fourteenth pin 14 is configured to provide an auxiliary negative voltage to ensure the voltage stability of the first high-voltage amplification circuit. The fifteenth pin 15 is electrically connected to the first capacitor, to compensate the first high-voltage amplification circuit, and improve the stability of the first high-voltage amplification circuit. The sixteenth pin 16 electrically connects the second capacitor to compensate the first high-voltage amplification circuit and improve the stability of the first high-voltage amplification circuit. The eighteenth pin 18 is configured to monitor the temperature of the first high-voltage amplification circuit to prevent the circuit from being destroyed due to excessive temperature. The nineteenth pin 19 is configured to test whether the first high-voltage amplification circuit can work normally. The twentieth pin 20 is configured to receive the enable signal.

In some embodiments of the present disclosure, as shown in FIG. 1 and FIG. 2, the haptic feedback display device further includes a reserved connector 250, which is fixedly arranged on the first circuit board 100 and is electrically connected with the first circuit board 100. The reserved connector 250 includes at least one port.

For example, the reserved connector can include 1 port, 2 ports, 5 ports, 8 ports, 10 ports . . . 20 ports, 21 ports, etc., the number of ports included in the reserved connector can be set according to the requirements, which will not be limited here.

For example, when the haptic feedback display device needs to add functions that it does not currently have, such as detection functions, the circuit with the detection function can be mounted on the reserved connector by plugging. Of course, it is also possible to add circuits with other functions, which will not be limited here.

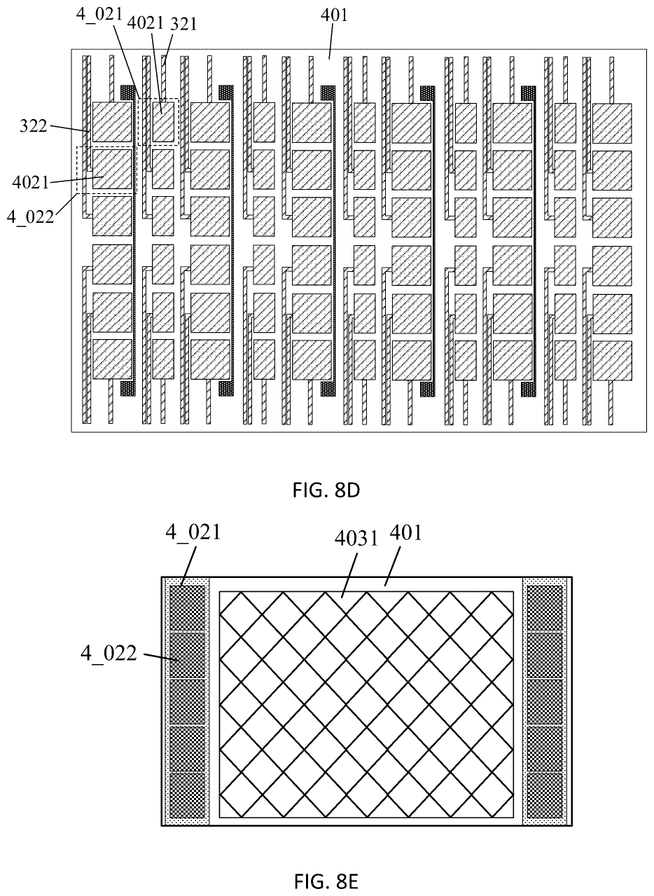

For example, as shown in FIG. 7, taking the reserved connector 250 including 14 ports as an example, the detection circuit 360 includes a thirty-third pin 33, a thirty-fourth pin 34, a thirty-fifth pin 35, a thirty-sixth pin 36, a thirty-seventh pin 37, a thirty-eighth pin 38, a thirty-ninth pin 39, a fortieth pin 40, a forty-first pin 41, a forty-second pin 42, a forty-third pin 43, a forty-fourth pin 44, a forty-fifth pin 45, a forty-sixth pin 46. The reserved connector 250 includes a thirty-third port 033, a thirty-fourth port 034, a thirty-fifty port 035, a thirty-sixth port 036, a thirty-seventh port 037, a thirty-eighth port 038, a thirty-ninth port 039, a fortieth port 040, a forty-first port 041, a forty-second port 042, a forty-third port 043, a forty-fourth port 044, a forty-fifty port 045, and a forty-sixth port 046. The thirty-third pin 33 and the thirty-fourth pin 34 are configured to be electrically connected to the ninth pin 9. The thirty-fifth pin 35, the thirty-sixth pin 36, the thirty-seventh pin 37, the thirty-eighth pin 38, the thirty-ninth pin 39, the fortieth pin 40, the forty-first pin 41, the forty-second pin 42, the forty-third pin 43, and the forty-fourth pin 44 are configured to be electrically connected to pins providing the control signals of the control signal terminals in the processing control circuit. The forty-fifth pin 45 and the forty-sixth pin 46 are configured to be grounded. The thirty-third port 033 is electrically connected to the thirty-third pin 33. The thirty-fourth port 034 is electrically connected to the thirty-fourth pin 34. The thirty-fifth port 035 is electrically connected to the thirty-fifth pin 35. The thirty-sixth port 036 is electrically connected to the thirty-sixth pin 36. The thirty-seventh port 037 is electrically connected to the thirty-seventh pin 37. The thirty-eighth port 038 is electrically connected to the thirty-eighth pin 38. The thirty-ninth port 039 is electrically connected to the thirty-ninth pin 39. The fortieth port 040 is electrically connected to the fortieth pin 40. The forty-first port 041 is electrically connected to the forty-first pin 41. The forty-second port 042 is electrically connected to the forty-second pin 42. The forty-third pin 043 is electrically connected to the forty-third pin 43. The forty-fourth port 044 is electrically connected to the forty-fourth pin 44. The forty-fifth port 045 is electrically connected to the forty-fifth pin 45. The forty-sixth port 046 is electrically connected to the forty-sixth pin 46.

For example, the thirty-third pin 33 and the thirty-fourth pin 34 supply power to the detection circuit 350 at the input target voltage (e.g., 5V). The thirty-third pin 33 and the thirty-fourth pin 34 are configured to be grounded. The thirty-fifth pin 35 to the forty-fourth pin 44 are configured to be electrically connected with pins of the processing control circuitry respectively with a resistor (e.g., a 330 resistor) for logic inputs and outputs.

In some embodiments of the present disclosure, as shown in FIG. 2, the haptic feedback display device further includes a low-voltage signal input circuit 360 fixedly arranged on the first circuit board 100, and electrically connected with a processing control circuit 330 and a first high-voltage amplification circuit 340 which are on the first circuit board 100. The low-voltage signal input circuit 360 is configured to generate and transmit a low-voltage signal to the first high-voltage amplification circuit 340 in response to the control signal output by the processing control circuit. The first high-voltage amplification circuit 340 amplifies the low-voltage signal into the first high-voltage signal.

For example, the low-voltage signal input circuit is mainly configured to generate a low-voltage signal. The processing control circuit controls the low-voltage signal input circuit through connecting with pins of the control signal terminal to generate the subsequent required low-voltage signal. The maximum voltage value of the low-voltage signal includes 10V, and the maximum frequency includes 50 KHz. The low-voltage signal input circuit is electrically connected with the first high-voltage amplification circuit, and the low-voltage signal is output to the high-voltage amplification circuit, and the first high-voltage amplification circuit amplifies the low-voltage signal into the first high-voltage signal.

Under normal circumstances, in the haptic feedback display device of different structures, the low-voltage signal input circuits adopted are approximately the same, that is, the low-voltage signal input circuit can be adapted to the haptic feedback display device of different structures, so the low-voltage signal input circuit can be fixedly arranged on the first circuit board.

In some embodiments of the present disclosure, as shown in FIG. 2, the haptic feedback display device further includes a display panel 400, a display driving circuit 370 fixedly arranged on the first circuit board 100 and electrically connected with the processing control circuit 330 on the first circuit board. The display driving circuit 370 is also connected with the display panel 400 through the first circuit board 100. The display driver circuit 370 is configured to control the display panel 100 to display the screen in response to the control signal output by processing control circuit 330.

For example, the display driver circuit mainly includes the High Definition Multimedia Interface (HDMI) and the display driver related circuits (such as chips, memory, etc). The HDMI of the display driver circuit is electrically connected with the display panel through the HDMI cable and is configured to control the display panel to display the display screen.

Exemplarily, the display panel can be a haptics panel.

Exemplarily, the haptic feedback display device provided by an embodiment of the present disclosure can be applied to medical, automotive electronics, motion tracking systems, and other fields. It is especially suitable for the field of wearable devices, medical monitoring and treatment in vitro or implanted in the human body, or applied to artificial intelligence in the field of electronic skin. Specifically, the haptic feedback display device can be applied to brake pads, keyboards, mobile terminals, game controllers, vehicles, smart homes and other haptic feedback display devices that can produce vibration and mechanical properties.

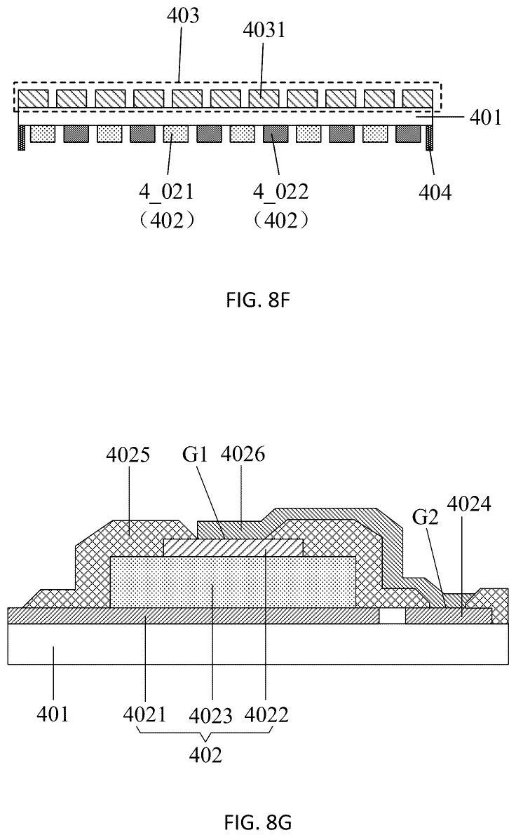

In some embodiments of the present disclosure, as shown in FIG. 8A to FIG. 8F, the display panel 400 includes a base substrate 401, a plurality of drivers 402 arranged in an array on a side of the base substrate 401, and a touch layer 403 located on a side of the base substrate 401 facing away from the driver 402. The driver 402 is configured to vibrate under the drive of the first high-voltage signal output by the first high-voltage amplification circuit to drive the base substrate 401 to vibrate. The display panel 400 provided by an embodiment of the present disclosure can realize a touch function (such as judging the touch position) and a haptic reproduction function by adopting a structure integrated with a base substrate 401 and a touch layer 403.

For example, when the first high-voltage signal output by the first high-voltage amplifier circuit cannot make the driver 402 work normally, the current first high-voltage amplifier circuit can be replaced with a new first high-voltage amplifier circuit that can make the driver 402 work normally, that is, the current first high-voltage amplifier circuit can be removed from the fourth adapting connector, and the new first high-voltage amplifier circuit can be mounted on the fourth adapting connector, so that the new first high-voltage amplifier circuit can be configured to drive the driver to work normally.

In some embodiments of the present disclosure, as shown in FIG. 8A to FIG. 8F, the touch layer 403 is attached to the surface of the base substrate 401 to provide the system with information such as the touch position during the touch process. Exemplarily, the touch layer 403 is divided into multiple touch electrodes 4031 arranged at intervals. For example, the touch electrodes 4031 can be self-capacitive touch electrodes, so that the touch function can be implemented using self-capacitive technology to determine the position coordinates of the touch position. The touch electrode 4031 can also be a mutual-capacitive touch electrode, so that the touch function can be realized by using mutual-capacitance technology to determine the position coordinates of the touch position.

In some embodiments of the present disclosure, as shown in FIG. 8A, the driver 402 can be a piezoelectric film. The first high-voltage signal output by the first high-voltage amplification circuit can directly provide vibration excitation, so that the display panel 400 produces a haptics effect. For example, the piezoelectric film is a transparent piezoelectric film.

In some embodiments of the present disclosure, as shown in FIG. 8A to FIG. 8F, the base substrate 401 is a substrate that is in direct contact with haptic senses such as fingers, and may be a notebook touchpad, a display screen, etc. Specifically, the base substrate 401 may be a substrate made of glass, a substrate made of silicon or silicon dioxide (SiO₂), a substrate made of sapphire, or a substrate made of a metal wafer, which will not be limited here, and those skilled in the art can set up the base substrate according to the needs of the actual application.

In some embodiments of the present disclosure, as shown in FIG. 8G, which is a schematic diagram of the cross-sectional structure of a driver 402 including a bottom electrode 4021 and a top electrode 4022 opposite each other, a piezoelectric layer 4023 located between the bottom electrode 4021 and the top electrode 4022, an insulating layer 4025 located on a side of the top electrode 4022 facing away from the piezoelectric layer 4023, and a wiring layer 4026 located on a side of the insulating layer 4025 facing away from the piezoelectric layer 4023. The driver 402 may also include: a bonding electrode 4024 arranged on a layer same as a layer where the bottom electrode 4021 is located. The bonding electrode 4024 is arranged close to the edge of the base substrate 401. The insulating layer 4025 has a first through hole G1 corresponding to the top electrode 4022. One end of the wiring layer 4026 is electrically connected with the top electrode 4022 through a first through hole G1, and the other end of the wiring layer 4026 is electrically connected with the bonding electrode 4024 through a second through hole G2 penetrating through the insulating layer 4025.

In some embodiments of the present disclosure, as shown in FIG. 8A to FIG. 8F, the plurality of drivers 402 is divided into at least one haptic-sensing piezoelectric device and at least one haptic-driving piezoelectric device. That is, a part of the drivers 402 can be set up as a haptic-sensing piezoelectric device, and the rest of the drivers can be set up as a haptic-driving piezoelectric device. For example, a haptic-sensing piezoelectric device and a haptic-driving piezoelectric device can be set up separately. Alternatively, a haptic-sensing piezoelectric device and a haptic-driving piezoelectric device may be arranged in a plurality (i.e., at least two, or more) respectively. The plurality of haptic-sensing piezoelectric devices 4_021 and the plurality of haptic-driving piezoelectric devices 4_022 are uniformly distributed on the base substrate 401.

Optionally, as shown in FIG. 8A, the plurality of haptic-sensing piezoelectric devices 4_021 and the plurality of haptic-driving piezoelectric devices 4_022 may be arranged on the base substrate 401 in a checkerboard arrangement.

Optionally, as shown in FIG. 8B, the plurality of haptic-sensing piezoelectric devices 4_021 may be divided into multiple columns, and the plurality of haptic-driving piezoelectric devices 4_022 may also be divided into multiple columns, and a column of haptic-sensing piezoelectric devices 4_021 and a column of haptic-driving piezoelectric devices 4_022 are arranged alternately. The bottom electrodes 4021 of the haptic-sensing piezoelectric devices 4_021 in a column of haptic-sensing piezoelectric devices 4_021 are arranged at intervals with each other, and the bottom electrodes 4021 of the haptic-driving piezoelectric devices 4_022 in a column of haptic-driving piezoelectric devices 4_022 are also arranged at intervals from each other. For example, the number of haptic-sensing piezoelectric devices 4_021 in a column of haptic-sensing piezoelectric devices 4_021 is less than the number of haptic-driving piezoelectric devices 4_022 in a column of haptic-driving piezoelectric devices 4_022. Further, the driver 402 further includes a lead electrode 4_025 arranged on a layer same as a layer where the bottom electrode 4021 is located. The lead electrode 4_025 is electrically connected with the bottom electrode 4021, and the lead electrode 4_025 is configured to be grounded. In addition, a lead electrode through hole 4_41 is formed at the position of the lead electrode 4_025, so that the external lead wire and the lead electrode 4_025 are connected by silver glue and other means.

Optionally, as shown in FIG. 8C, the plurality of haptic-sensing piezoelectric devices 4_021 may be divided into multiple columns, and the plurality of haptic-driving piezoelectric devices 4_022 may also be divided into multiple columns, and a column of haptic-sensing piezoelectric devices 4_021 and a column of haptic-driving piezoelectric devices 4_022 may be arranged alternately. In addition, the haptic-sensing piezoelectric device 4_021 and the haptic-driving piezoelectric device 4_022 are arranged in array. The bottom electrodes 4021 of the haptic-sensing piezoelectric device 4_021 in a column of haptic-sensing piezoelectric devices 4_021 are electrically connected to each other, and the bottom electrodes 4021 of the haptic-driving piezoelectric device 4_022 in a column of haptic-driving piezoelectric devices 4_022 are electrically connected to each other. For example, in a column of haptic-sensing piezoelectric devices 4_021, the bottom electrode 4021-1 of the haptic-sensing piezoelectric device 4_021 is electrically connected with the bottom electrode 4021-2 through the first connecting part 0221, and the bottom electrodes 4021-2 are electrically connected with each other through the first connecting part 0221. In addition, in a column of haptic-driving piezoelectric devices 4_022, the bottom electrode 4021-3 of the haptic-driving piezoelectric device 4_022 is electrically connected with the bottom electrode 4021-4 through a second connecting part 0211, and the bottom electrode 4021-4 is electrically connected with the bottom electrode 4021-4 through the second connecting part 0211.

Optionally, as shown in FIG. 8D, the plurality of haptic-sensing piezoelectric devices 4_021 may be divided into multiple columns, the plurality of haptic-driving piezoelectric devices 4_022 may also be divided into multiple columns, and a column of haptic-sensing piezoelectric devices 4_021 and a column of haptic-driving piezoelectric devices 4_022 are arranged alternately. In addition, the haptic-sensing piezoelectric device 4_021 and the haptic-driving piezoelectric device 4_022 are arranged in array. The bottom electrodes 4021 of the haptic-sensing piezoelectric device 4_021 in a column of haptic-sensing piezoelectric devices 4_021 are arranged at intervals between each other, and the bottom electrodes 4021 of the haptic-driving piezoelectric device 4_022 in a column of haptic-driving piezoelectric devices 4_022 are arranged at intervals between each other. Moreover, each haptic-sensing piezoelectric device 4_021 is connected to a corresponding haptic-sensing signal line 322, so as to transmit a signal through the haptic-sensing signal line 322. Each haptic-driving piezoelectric device 4_022 is connected to a corresponding haptic-driving signal line 321, so as to transmit a signal through a haptic-driving signal line 321.

Optionally, as shown in FIG. 8E, the haptic-sensing piezoelectric devices 4_021 and the haptic-driving piezoelectric devices 4_022 can also be arranged in the non-display area of the display panel. In addition, in one column, the haptic-sensing piezoelectric device 4_021 and the haptic-driving piezoelectric device 4_022 are arranged alternately. Further, the haptic-sensing piezoelectric devices 4_021 and the haptic-driving piezoelectric devices 4_022 can be connected to the eleventh pin of the first high-voltage amplification circuit through the first circuit board.

Of course, the plurality of haptic-sensing piezoelectric devices and the plurality of haptic-driving piezoelectric devices may also be arranged on the base substrate 401 in other arrangements, which are not limited by the disclosure.

For example, in a haptic-sensing piezoelectric device, the bottom electrode 4021 is grounded, the bonding electrode 4024 is connected to the driving detection terminal. When the finger touches the surface of the base substrate 401, the top electrode 4022 generates a charge signal, which can be output by the driving detection terminal.

For example, in a haptic-driving piezoelectric device, the bottom electrode 4021 is grounded, the bonding electrode 4024 is connected to the driving voltage input terminal. The driving control signal input at the driving voltage input terminal is an alternating voltage signal. An alternating voltage signal (VAC) is loaded to the top electrode 4022 through the driving voltage input terminal, so that an alternating electric field can be formed between the top electrode 4022 and the bottom electrode 4021, and the frequency of the alternating electric field is the same as the frequency of the alternating voltage signal. Under the action of alternating electric field, the piezoelectric layer 4023 undergoes deformation and produces a vibration signal, the frequency of the vibration signal is the same as the frequency of the alternating electric field. When the frequency of the vibration signal is close to or equal to the natural frequency of the base substrate 401, the base substrate 401 resonates, the amplitude is enhanced, and a haptics signal is generated. When a finger touches the surface of the base substrate 401, the change of friction force can be clearly felt. In practical application, the friction force on the surface of the base substrate 401 can be adjusted by the resonance generated between the piezoelectric layer 4023 and the base substrate 401, so that the texture of the object can be reproduced on the surface of the base substrate 401.

In some embodiments of the present disclosure, the bottom electrode 4021 and the bonding electrode 4024 may be formed with the same material and using a single mask patterning process.

It should be noted that the bottom electrodes 4021 of all drivers 402 in FIG. 8A can be a patterned structure or a full-sided structure. The piezoelectric layers 4023 of all drivers 402 is a patterned structure or a full-sided structure. The top electrodes 4022 of all drivers 402 is a patterned structure, for example, the top electrodes 4022 of all drivers 402 are a patterned structure corresponding to the piezoelectric layer 4023.

In the specific implementation, the material of the piezoelectric layer can be lead zirconate titanate (Pb(Zr,Ti)O₃, PZT), and can also be at least one of aluminum nitride (AlN), ZnO (zinc oxide), barium titanate (BaTiO₃), lead titanate (PbTiO₃), potassium niobate (KNbO₃), lithium niobate (LiNbO₃), lithium tantalum (LiTaO₃), or gallium lanthanum silicate (La₃Ga₅SiO₁₄). The specific materials for making piezoelectric layers can be selected according to the actual use needs of those skilled in the art, and there is no limitation here. When PZT is configured to make a piezoelectric layer, because PZT has a high-voltage electric coefficient, the piezoelectric characteristics of the corresponding display panel 400 are guaranteed, and the corresponding display panel 400 can be applied to the haptics device, and PZT has high light transmittance, and the display quality of the display apparatus is not affected when it is integrated into the display apparatus.

In the specific embodiment, the top electrode and bottom electrode of the piezoelectric device are transparent conductive materials, for example, can be made of indium tin oxide (ITO), can also be made of indium zinc oxide (IZO), can also be made of one of titanium (Ti—Au) alloy, titanium aluminum titanium (Ti—Al—Ti) alloy, titanium molybdenum (Ti—Mo) alloy. In addition, the top electrode and bottom electrode of the piezoelectric device can also be made of one of titanium (Ti), gold (Au), silver (Ag), molybdenum (Mo), copper (Cu), tungsten (W), and Chromium (Cr), and those skilled in the art can set up the above-mentioned transparent conductive electrode according to the needs of practical application, and there is no restriction herein.

In some embodiments of the present disclosure, as shown in FIG. 8A to FIG. 8F, the display panel further includes a support layer 404 located on a base substrate 401. The support layer 404 and the driver 402 are located on the same side of the base substrate 401. Specifically, the support layer 404 mainly plays the role of connecting the base substrate 401 and a device. The device can be either a support frame or a support plate. Specifically, the device mainly plays the role of supporting the display panel 400, and can be the bezel of the display screen, the bezel of the notebook touchpad, etc. Specifically, the device and the support layer 404 can be fixedly connected by an adhesive layer (e.g., optical clear adhesive, OCA), etc.

In some embodiments of the present disclosure, the material of the support layer 404 may include, but is not limited to, at least one of the following: rubber, sponge, foam, or polydimethylsiloxane (PDMS). Specifically, the support layer 404 and the base substrate 401 may be fixedly connected by an adhesive layer (such as optical clear adhesive, OCA), etc. Exemplarily, the support layer 404 may include support portions 411 located around the base substrate 401 and arranged around all drivers 402. Optionally, the orthographic projection shape of the support layer 404 (support portions 411) on the base substrate 401 includes a square, a triangle, a circle, a trapezoid, or a polygon. Of course, the present disclosure does not limit the specific position of the support layer 404. The position of the support layer 404 can be determined according to the needs of practical application, and is not limited herein.

Under normal circumstances, in the haptic feedback display device of different structures, display driving circuits adopted are approximately the same, that is, the display driving circuit can be adapted to the haptic feedback display device of different structures, so the display driving circuit can be fixedly arranged on the first circuit board.

In some embodiments of the present disclosure, as shown in FIG. 2, the haptic feedback display device further includes:
a storage circuit 380 fixedly arranged on the first circuit board 100 and electrically connected with the processing control circuit 330 on the first circuit board 100, and the storage circuit 380 is configured to store the information required for the processing control circuit 330.

For example, the storage circuit mainly includes a memory and a configuration circuit for the processing control circuit. The memory is configured to store the information required by the processing control circuit (such as waveform data information, etc), and the configuration circuit for the processing control circuit is mainly configured to program and debug the processing control circuit.

Under normal circumstances, in the haptic feedback display device of different structures, memory circuits adopted are approximately the same, that is, the storage circuit can be adapted to the haptic feedback display device of different structures, so the storage circuit can be fixedly arranged on the first circuit board.

As an example, as shown in FIG. 2, the haptic display also includes a connection port, for example, the connection port includes a Universal Serial Bus (USB) interface. Exemplarily, the connection port is configured to connect mice, keyboards, and other external devices.

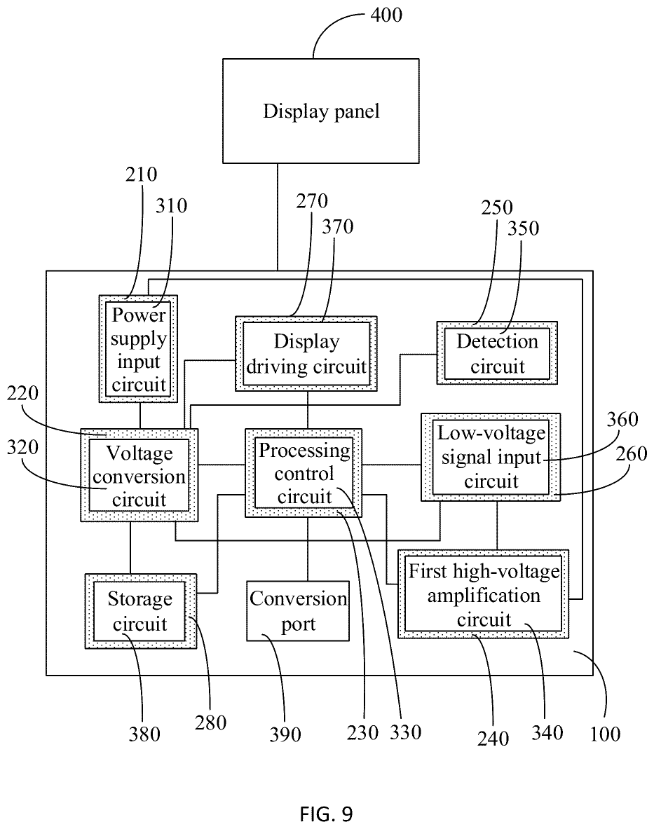

Some embodiments of the disclosure also provide schematic diagrams of some other structures of the haptic feedback display device. As shown in FIG. 9, and it is deformed for the above embodiments. The differences between the present embodiment and the above embodiments are only described below, and their general similarities are not repeated herein.

In some other embodiments of the present disclosure, as shown in FIG. 1 and FIG. 8, the adapting connector 200 includes a fifth adapting connector 260 fixedly arranged on the first circuit board 100 and electrically connected with the first circuit board 100. The functional circuit assembly 300 includes a low-voltage signal input circuit 360 mounted on the fifth adapting connector 260 in a plug-in mode. The low-voltage signal input circuit 360 is electrically connected to a processing control circuit 330 and a first high-voltage amplification circuit 340 on the first circuit board 100 through the fifth adapting connector 260. The low-voltage signal input circuit is configured to generate and transmit a low-voltage signal to the first high-voltage amplification circuit 340 in response to the control signal output by the processing control circuit 330. The first high-voltage amplification circuit 340 amplifies the low-voltage signal into the first high-voltage signal.

When the low-voltage signal input circuit needs to be replaced (for example, the current low-voltage signal input circuit is damaged and cannot work normally), the low-voltage signal input circuit currently mounted on the fifth adapting connector can be removed, and a new low-voltage signal input circuit can be mounted on the fifth adapting connector.

In some other embodiments of the present disclosure, as shown in FIG. 1 and FIG. 8, the haptic feedback display device further includes a display panel 400. The adapting connector 200 includes a sixth adapting connector 270 fixedly arranged on the first circuit board 100 and electrically connected with the first circuit board 100. The functional circuit assembly 300 includes a display driving circuit 370 mounted on the sixth adapting connector 270 in a plug-in mode. The display driving circuit 370 is electrically connected to the processing control circuit 330 on the first circuit board 100 through the sixth adapting connector 270, and the display driving circuit 370 is also electrically connected to the display panel 400 through the first circuit board 100. The display drive circuit 370 is configured to control the display panel 400 to display the screen in response respond to the control signal output by processing the control circuit 330.

When the display driving circuit needs to be replaced (for example, the current display driving circuit is damaged and cannot work normally), the display driving circuit currently mounted on the sixth adapting connector can be removed, and a new display driving circuit can be mounted on the sixth adapting connector.

In some other embodiments of the present disclosure, as shown in FIG. 1 and FIG. 8, the adapting connector 200 includes a seventh adapting connector 280 fixedly arranged on the first circuit board 100 and electrically connected with the first circuit board 100. The functional circuit assembly 300 includes a storage circuit 380 mounted on the seventh adapting connector 280 in a plugged mode. The storage circuit 380 is electrically connected to the processing control circuit 330 on the first circuit board 100 through the seventh adapting connector 280, and the storage circuit 380 is configured to store the information required by the processing control circuit 330.

When the storage circuit needs to be replaced (for example, the current storage circuit is damaged and cannot work normally), the storage circuit currently mounted on the seventh adapting connector can be removed, and a new storage circuit can be mounted on the seventh adapting connector.

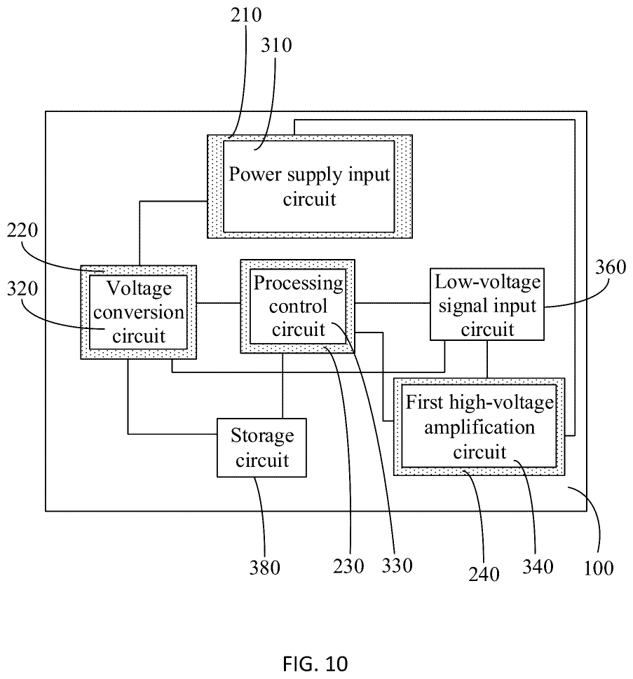

Some embodiments of the disclosure also provides schematic diagrams of some other structures of the haptic feedback display device. As shown in FIG. 10, and it is deformed for the above embodiments. The differences between the present embodiment and the above embodiments are only described below, and their general similarities are not repeated herein.

In another embodiments of the present disclosure, when the haptic feedback display device needs relatively high requirements for the size of the first circuit board, some non-core function circuits can be removed, such as: display drive circuit, reserved connector and connection ports.

As illustratively shown in FIG. 10, only the power input circuit 310, the voltage conversion circuit 320, the processing control circuit 330, the first high-voltage amplification circuit 340, the low-voltage signal input circuit 360, and the storage circuit 380 are retained, so that the size of the first circuit board can be reduced. For example, if the size of the first circuit board shown in FIG. 2 is 15*15.6 cm, the size of the first circuit board shown in FIG. 10 is 9.9*9.2 cm. It can be seen that the size of the first circuit board is greatly reduced, and it is more conducive to the pursuit of small size of the haptic feedback display device, and the space is saved.

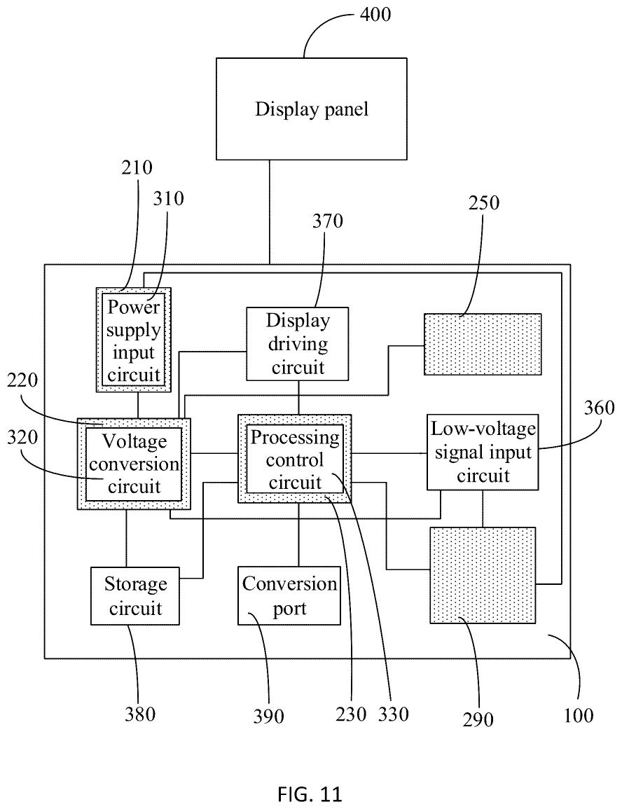

Some embodiments of the present disclosure also provide schematic diagrams of some other structures of the haptic feedback display device. As shown in FIG. 11, it is deformed for the above embodiments. The differences between the present embodiment and the above embodiments are only described below, and their general similarities are not repeated herein.

In some embodiments of the present disclosure, the haptic feedback display device further includes a second circuit board connected with the first circuit board through cables, at least one expansion connector fixedly arranged on the second circuit board and electrically connected with the second circuit board, at least one second high-voltage amplification circuit corresponding one-to-one with the at least one expansion connector. The second high-voltage amplification circuit is mounted on the corresponding expansion connector in a plugging mode, and is electrically connected with the first circuit board through the expansion connector and the second circuit board, and the second high-voltage amplification circuit is configured to output the first high-voltage signal.

For example, one second high-voltage amplifier circuit outputs one first high-voltage signal, and when the haptic feedback display device requires a plurality of first-voltage signals to drive, a plurality of second high-voltage amplifier circuits are required. Because there are certain requirements for the size of the first circuit board, a plurality of second high-voltage amplification circuits cannot be arranged on the first circuit board, so a second circuit board is arranged.

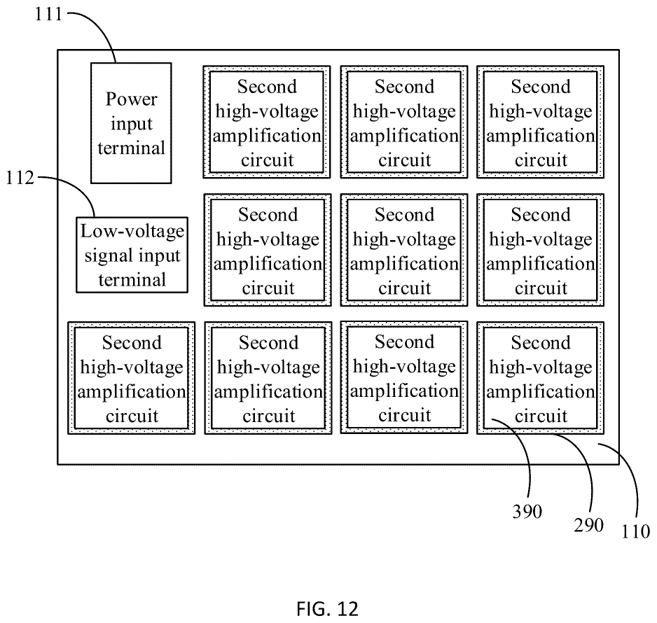

Below taking 10 first high-voltage signals for driving as an example, as shown in FIG. 11 and FIG. 12, the haptic feedback display device further includes ten second high-voltage amplification circuits 390 and ten expansion connectors 290. The ten second high-voltage amplification circuits 390 and the ten expansion connectors 290 correspond one-to-one respectively. The ten second high-voltage amplification circuits 390 are respectively mounted on corresponding expansion connector 290 in a plug-in mode. The first circuit board is connected to the power input terminal 111 and the low-voltage signal input terminal 112 on the second circuit board 110 through cables. The power input terminal 111 is configured to supply power to the second high-voltage amplification circuit. The low-voltage signal input terminal 112 is configured to provide a low-voltage signal generated by a low-voltage signal input circuit on the first circuit board to a second high-voltage amplification circuit 390.

Although preferred embodiments of the present disclosure have been described, those embodiments may make additional changes and modifications to these embodiments once they have knowledge of the basic concept of inventive step. Therefore, the attached claims are intended to be construed to include the preferred embodiments and all changes and modifications that fall within the scope of this disclosure.

Obviously, a person skilled in the art may make various changes and variants to the embodiments of the present disclosure without departing from the spirit and scope of the embodiments of the present disclosure. Thus, if these modifications and variants of the present disclosure embodiments fall within the scope of the claims of the present disclosure and their equivalents, the present disclosure is also intended to include such modifications and variants.

1. A haptic feedback display device, comprising:
a first circuit board;
an adapting connector fixedly arranged on the first circuit board and electrically connected with the first circuit board;
a functional circuit assembly mounted on the adapting connector in a plug-in mode, and electrically connected with the first circuit board through the adapting connector.

2. The haptic feedback display device of claim 1, wherein the functional circuit assembly comprises a power supply input circuit, the power supply input circuit is configured to provide a power supply voltage;
wherein the adapting connector comprises a first adapting connector;
wherein the power supply input circuit is electrically connected with the first circuit board through the first adapting connector.

3. The haptic feedback display device of claim 2, wherein the power supply input circuit comprises: a first pin, a second pin, a third pin, a fourth pin, and a fifth pin;
wherein the first adapting connector comprises a first port, a second port, a third port, a fourth port, and a fifth port;
wherein the first pin and the second pin are configured to be grounded; the third pin is configured to be electrically connected with a negative high-voltage signal terminal on the first circuit board; the fourth pin is configured to be electrically connected with a positive high-voltage signal terminal on the first circuit board; the fifth pin is configured to be electrically connected with a low-voltage signal terminal on the first circuit board;
wherein the first port is electrically connected with the first pin, the second port is electrically connected with the second pin, the third port is electrically connected with the third pin, the fourth port is electrically connected with the fourth pin, and the fifth port is electrically connected with the fifth pin.

4. The haptic feedback display device of claim 1, wherein the functional circuit assembly comprises a voltage conversion circuit, wherein the voltage conversion circuit is configured to convert a power supply voltage into a target voltage;
wherein the adapting connector further comprises a second adapting connector;
wherein the voltage conversion circuit is electrically connected with the first circuit board through the second adapting connector.

5. The haptic feedback display device of claim 4, wherein the voltage conversion circuit comprises a sixth pin, a seventh pin, an eighth pin, a ninth pin;
wherein the second adapting connector comprises a sixth port, a seventh port, an eighth port, a ninth port;
wherein the sixth pin and the seventh pin are configured to be grounded; the eighth pin is configured to be electrically connected with the fourth pin; the ninth pin is configured to be electrically connected with the fifth pin;
wherein the sixth port is electrically connected with the sixth pin, the seventh port is electrically connected with the seventh pin, the eighth port is electrically connected with the eighth pin, and the ninth port is electrically connected with the ninth pin.

6. The haptic feedback display device of claim 13, wherein the functional circuit assembly comprises a processing control circuit, wherein the processing control circuit is configured to output a control signal;
wherein the adapting connector comprises a third adapting connector;
the processing control circuit is electrically connected with the first circuit board through the third adapting connector.

7. The haptic feedback display device of claim 6, wherein the processing control circuit comprises at least n pins; the third adapting connector comprises at least n ports; the at least n pins are electrically connected with the at least n ports in a one-to-one manner;
wherein x of the at least n pins are configured to be electrically connected with a control signal terminal on the first circuit board; y of the at least n pins are configured to be grounded; z of the at least n pins are configured to be electrically connected with the ninth pin, wherein n=x+y+z, n is greater than or equal to 480, x is greater than or equal to 376, y is greater than or equal to 96, and z is greater than or equal to 8.

8. The haptic feedback display device of claim 71, wherein the functional circuit assembly comprises a first high-voltage amplification circuit, wherein the first high-voltage amplification circuit is configured to output a first high-voltage signal;
wherein the adapting connector comprises a fourth adapting connector;
the first high-voltage amplification circuit is electrically connected with the first circuit board through the fourth adapting connector.

9. The haptic feedback display device of claim 8, wherein the first high-voltage amplification circuit comprises a tenth pin, an eleventh pin, a twelfth pin, a thirteenth pin, a fourteenth pin, a fifteenth pin, a sixteenth pin, a seventeenth pin, an eighteenth pin, a nineteenth pin, a twentieth pin, a twenty-first pin, a twenty-second pin, a twenty-third pin, a twenty-fourth pin, a twenty-fifth pin, a twenty-sixth pin, a twenty-seventh pin, a twenty-eighth pin, a twenty-ninth pin, a thirtieth pin, a thirty-first pin, and a thirty-second pin;
wherein the fourth adapting connector comprises a tenth port, an eleventh port, a twelfth port, a thirteenth port, a fourteenth port, a fifteenth port, a sixteenth port, a seventeenth port, an eighteenth port, a nineteenth port, a twentieth port, a twenty-first port, a twenty-second port, a twenty-third port, a twenty-fourth port, a twenty-fifth port, a twenty-sixth port, a twenty-seventh port, a twenty-eighth port, a twenty-ninth port, a thirtieth port, a thirty-first port, and a thirty-second port;
wherein the tenth pin is configured to be electrically connected to the third pin; the eleventh pin is configured to be electrically connected with a first high-voltage signal output terminal on the first circuit board and the fourteenth pin; the twelfth pin is configured to be electrically connected with a first resistor on the first circuit board; the thirteenth pin is configured to electrically connect with a second resistor on the first circuit board; the fifteenth pin is configured to be electrically connected with a first capacitor on the first circuit board; the sixteenth pin is configured to be electrically connected with a second capacitor on the first circuit board; the seventeenth pin and the eighteenth pin are configured to be electrically connected with a low-voltage signal output terminal on the first circuit board; the nineteenth pin, the twentieth pin, and the twenty-first pin are configured to be connected with three of the x pins; the twenty-fourth pin is configured to be grounded; the thirty-second pin is configured to be electrically connected with the fourth pin and the thirty-first pin;
wherein the tenth pin is electrically connected with the tenth port, the eleventh pin is electrically connected with the eleventh port, the twelfth pin is electrically connected with the twelfth port, the thirteenth pin is electrically connected with the thirteenth port, the fourteenth pin is electrically connected with the fourteenth port, the fifteenth pin is electrically connected with the fifteenth port, the sixteenth pin is electrically connected with the sixteenth port, and the seventeenth pin is electrically connected with the seventeenth port, the eighteenth pin is electrically connected with the eighteenth port, the nineteenth pin is electrically connected with the nineteenth port, the twentieth pin is electrically connected with the twentieth port, the twenty-first pin is electrically connected with the twenty-first port, the twenty-second pin is electrically connected with the twenty-second port, the twenty-third pin is electrically connected with the twenty-third port, the twenty-fourth pin is electrically connected with the twenty-fourth port, the twenty-fifth pin is electrically connected with the twenty-fifth port, the twenty-sixth pin is electrically connected with the twenty-sixth port, the twenty-seventh pin is electrically connected with the twenty-seventh port, the twenty-eighth pin is electrically connected with the twenty-eighth port, the twenty-ninth pin is electrically connected with the twenty-ninth port, the thirtieth pin is electrically connected with the thirtieth port, the thirty-first pin is electrically connected with the thirty-first port, and the thirty-second pin is electrically connected with the thirty-second port.

10. The haptic feedback display device of claim 1, further comprising:
a reserved connector fixedly arranged on the first circuit board and electrically connected with the first circuit board; wherein the reserved connector comprises at least one port.

11. The haptic feedback display device of claim 1, further comprising:
a low-voltage signal input circuit fixedly arranged on the first circuit board and electrically connected with a processing control circuit and a first high-voltage amplification circuit on the first circuit board,
wherein the low-voltage signal input circuit is configured to generate and transmit a low-voltage signal to the first high-voltage amplification circuit in response to a control signal output by the processing control circuit, and the first high-voltage amplification circuit amplifies the low-voltage signal into a first high-voltage signal.

12. The haptic feedback display device of claim 1, wherein the adapting connector comprises a fifth adapting connector fixedly arranged on the first circuit board and electrically connected with the first circuit board;
wherein the functional circuit assembly comprises a low-voltage signal input circuit, the low-voltage signal input circuit is mounted on the fifth adapting connector in a plug-in mode and electrically connected with a processing control circuit and a first high-voltage amplification circuit on the first circuit board through the fifth adapting connector, and the low-voltage signal input circuit is configured to generate and transmit a low-voltage signal to the first high-voltage amplification circuit in response to a control signal output by the processing control circuit, the first high-voltage amplification circuit amplifies the low-voltage signal into a first high-voltage signal.

13. The haptic feedback display device of claim 1, further comprising:
a display panel;
a display driving circuit fixedly arranged on the first circuit board and electrically connected with a processing control circuit on the first circuit board, wherein the display driving circuit is further electrically connected with the display panel through the first circuit board;
wherein the display driving circuit is configured to control the display panel to display an image in response to a control signal output by the processing control circuit.

14. The haptic feedback display device of claim 1, further comprising:
a display panel;
wherein the adapting connector comprises a sixth adapting connector fixedly arranged on the first circuit board and electrically connected with the first circuit board;
wherein the functional circuit assembly comprises a display driving circuit, wherein the display driving circuit is mounted on the sixth adapting connector in a plug-in mode and is electrically connected with a processing control circuit on the first circuit board through the sixth adapting connector, and the display driving circuit is further electrically connected with the display panel through the first circuit board;
wherein the display driving circuit is configured to control the display panel to display an image in response respond to a control signal output of the processing control circuit.

15. The haptic feedback display device of claim 1, further comprising:
a storage circuit fixedly arranged on the first circuit board and electrically connected with a processing control circuit on the first circuit board, wherein the storage circuit is configured to store information required by the processing control circuit.

16. The haptic feedback display device of claim 1, wherein
the adapting connector comprises a seventh adapting connector fixedly arranged on the first circuit board and electrically connected with the first circuit board;
wherein the functional circuit assembly comprises a storage circuit, wherein the storage circuit is mounted on the seventh adapting connector in a plug-in mode, and is electrically connected with a processing control circuit on the first circuit board through the seventh adapting connector, and the storage circuit is configured to store information required by the processing control circuit.

17. The haptic feedback display device of claim 1, further comprising:
a second circuit board connected with the first circuit board through a cable;
at least one expansion connector fixedly arranged on the second circuit board and electrically connected with the second circuit board;
at least one second high-voltage amplification circuit corresponding to the at least one expansion connector in an one-to-one manner, wherein the at least one second high-voltage amplification circuit is mounted on the at least one expansion connector in a plug-in mode, and is electrically connected with the first circuit board through the at least one expansion connector and the second circuit board, the at least one second high-voltage amplification circuit is configured to output a first high-voltage signal.
